(19) United States
(12) Patent Application Publication
(10) Pub. No.: US 2010/0246171 A1
(43) Pub. Date: Sep. 30, 2010

(54) LED Replacement Projector Light Source

(76) Inventor: Timothy J. Scale, Downers Grove, IL (US)

Correspondence Address: CLIFFORD H. KRAFT, 320 ROBIN HILL DR., NAPERVILLE, IL, 60540, US

(21) Appl. No.: 12/411,577

(22) Filed: Mar. 26, 2009

(51) Int. Cl. F21V 7/00; F21S 4/00

(52) U.S. Cl. 362/235; 362/249.02

(57) ABSTRACT

An LED replacement light source for typical flash lamp projector bulbs. The LED source can be configured in the same form factor as the original bulb module. Clusters of LEDs or LEDs in series and parallel can be used to replace the projector lamp module. A varistor or other surge protector can be used to protect the LED array from the initial high voltage firing spike supplied by the power supply. The replacement module can have LEDs mounted on a heat sink with a collimator in front of the LEDs and an optional reflector.

### BACKGROUND

1. Field of the Invention

The present invention relates generally to the field of LED light sources and more particularly to an LED light replacement for a projector.

2. Description of the Prior Art

Light projectors are well known in the art. They are used extensively project movies and slides and to make live presentations from computer files such as from PowerPoint (TM Microsoft Corporation) and other files that reside on computers. Prior art projectors typically contain a sealed arc lamp that puts out 500 to 3000 or more Lumens. Many of these lamps are of the mercury vapor type. These bulbs generate very bright light to illuminate a screen many feet away from the bulb. Most of the prior art bulbs have a reflector and a special power supply. These bulbs are expensive to manufacture as are the power supplies, and hence the bulb replacement costs are high. A typical prior art mercury vapor bulb lasts between 1500 and 2000 working hours. It is known that these bulbs can actually explode sometimes when they fail.

These prior art bulbs require a special power supply to drive them. To start, they need a very high voltage spike. Then, when they fire, they consume a fairly constant current. To lengthen life, most projector manufacturers bring up bulb current slowly over several moments after the initial firing. If the bulb fails to fire, the power supply generally shuts down. In particular, prior art projectors deliver a very high voltage pulse initially, then a medium power pulse longer in duration followed by a moderate voltage for the duration of the time the projector is operating. The projector power also slowly increases over a period of time of around a minute to avoid high current pulses that could fracture the bulb. The projector also normally has a timed fan circuit that slowly cools the bulb once the projector light source is turned off.

Because of the expense in replacing these bulbs, it would be advantageous to have an LED light source that could immediately fit into a light module socket and replace the lamp without any changes required of the projector's power supply.

### SUMMARY OF THE INVENTION

The present invention relates to an LED replacement light source for typical flash lamp projector bulbs. The LED source can be configured in the same form factor as the original bulb module. Clusters of LEDs or LEDs in series and parallel can be used to replace the projector lamp module. A varistor can be used to protect the LED array from the initial high voltage firing spike supplied by the power supply. The replacement module can have LEDs mounted on a heat sink with a collimator in front of the LEDs and an optional reflector. Generally the present invention contains no resistive parts that can dissipate extra energy. While an LED light source of the present invention can use around 90 to 250 watts of power, most of this power is converted directly to light so that the LED light source does not require the same amount of cooling that is required for an arc lamp source. The LEDs can be equipped with a heat source that can be cooled by the projector's fan.

### DESCRIPTION OF THE FIGURES

Attention is now called to several illustrations presented to show some of the features of the present invention:

FIG. 1 shows a break-apart diagram of an LED lamp replacement module.

FIG. 2 shows a schematic diagram an embodiment of the present invention.

FIG. 3 shows a schematic diagram of a replacement module designed to run on AC.

FIG. 4 shows a schematic diagram of 3 parallel groups of 2 series LEDs each.

FIG. 5 shows a schematic diagram of 6 LEDs connected in parallel.

FIG. 6 shows the schematic diagram of FIG. 2 with a protective zener diode.

Several drawings and diagrams have been presented to aid in understanding the present invention. The scope of the present invention is not limited to what is shown in the figures.

### DESCRIPTION OF THE INVENTION

The present invention relates to a replacement Light Emitting Diode (LED) light source module that is directly interchangeable with arc lamp sources currently used in light projectors made by several different manufacturers.

The modules of the present invention can be used with both DC and AC lamp sources. The most common is DC, where the projector power supply simply acts as a controlled current source after the initial firing of the arc lamp.

The present invention replaces a projector bulb with an LED source that can last over 10,000 hours and not be subject to explosion. The replacement module does not need a complicated power supply; however, it is designed to be plug replaceable into projectors that have arc lamp power supplies. The LED source of the present invention can alternately be designed into new projectors from the outset. Generally the LED source contains no resistive parts or other parts that dissipate power other than the LEDs themselves. The replacement module of the present invention takes the exact footprint or form factor of the old device.

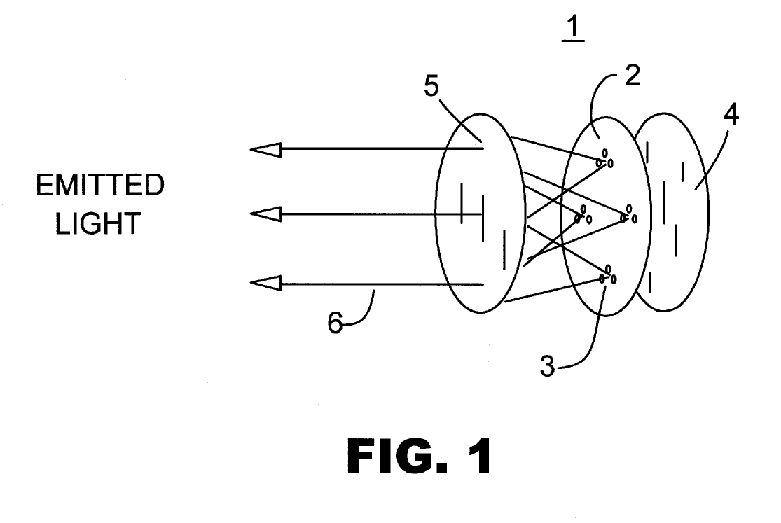

Turning to FIG. 1, a break-apart drawing of an embodiment of the present invention can be seen. This particular module 1 uses four clusters of three LEDs each. In general, any number of LEDs in any series or parallel arrangement is within the scope of the present invention. The LEDs can be clustered or separate.

In general, it is necessary to mount the LEDs 3 on a heat sink 2 so that they do not overheat. The heat sink 2 can be equipped with convection fins or can simply be a metal plate. The total amount of heat that must be removed depends on the number and types of LEDs as well as the total power being used. LEDs are very efficient with a large portion of the power producing light. Still, in general, it is necessary to have some method of removing heat from the LEDs. Any heat removal method is within the scope of the present invention.

A collimator 5 can be mounted in front of the LEDs 3 to collimate the light into a beam 6. An optional reflector 4 can be used behind the LEDs 3.

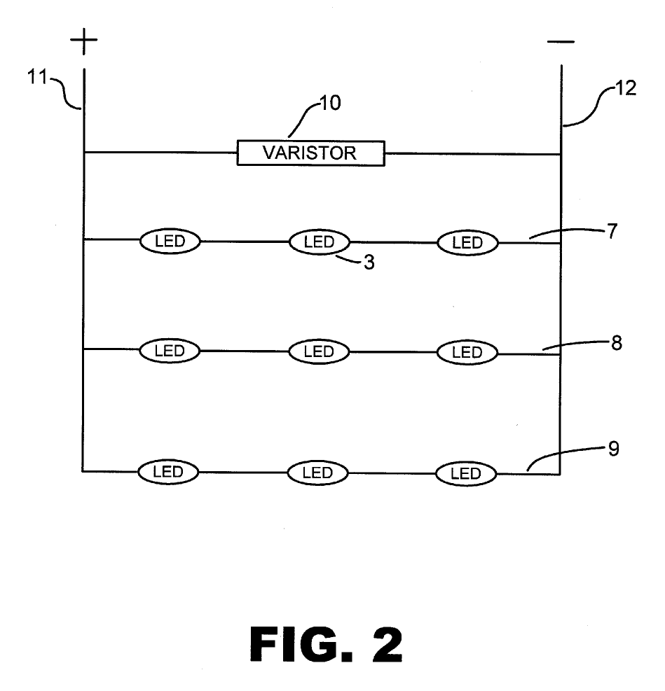

FIG. 2 shows a schematic of an embodiment of the present invention designed to run on DC. In this particular embodiment, three groups of three LEDs each are arranged in series/parallel. In general each LED 3 needs around 3.5-4.5 VDC across it. Three LEDs in series can be run at 12 VDC. Different numbers of series groups wired in parallel (7, 8, 9) can be used for different light outputs. Different LEDs can also be used. For example Luxeon White LEDs that run from 700 to 1000 mA output around 65-80 Lumens each. Nine of these as shown in FIG. 2 would output approximately 585-720 Lumens. This may not be bright enough for some applications. Endor Rebel Cool White Tri-Emitter Model 7007-PWC-08-3 LEDs are clustered as groups of three LEDs. Each group outputs around 435 Lumens at around 700 mA. To achieve 3000 Lumans, would require around seven groups with a total current of near 4.9 Amps. The total number of LEDs that can be used depends on the available current from the projector power supply as well as the total heat that can be removed. The total number of LEDs in series should be chosen to match the projector operating DC voltage so that approximately 3.5-4.5 VDC appears across each individual LED (10.5-13.5V across three LEDs).

In addition to simply drawing DC current and producing light, the replacement module of the present invention must tolerate the initial firing surge by the power supply. While numerous ways to do this are within the scope of the present invention, a particularly good way is to place a varistor surge protector 10 across the DC line (11, 12). A particular surge protector that can be used is sold by Radio Shack Corporation as a Heavy Duty MOV Surge Suppressor, Varistor Model #276-568.

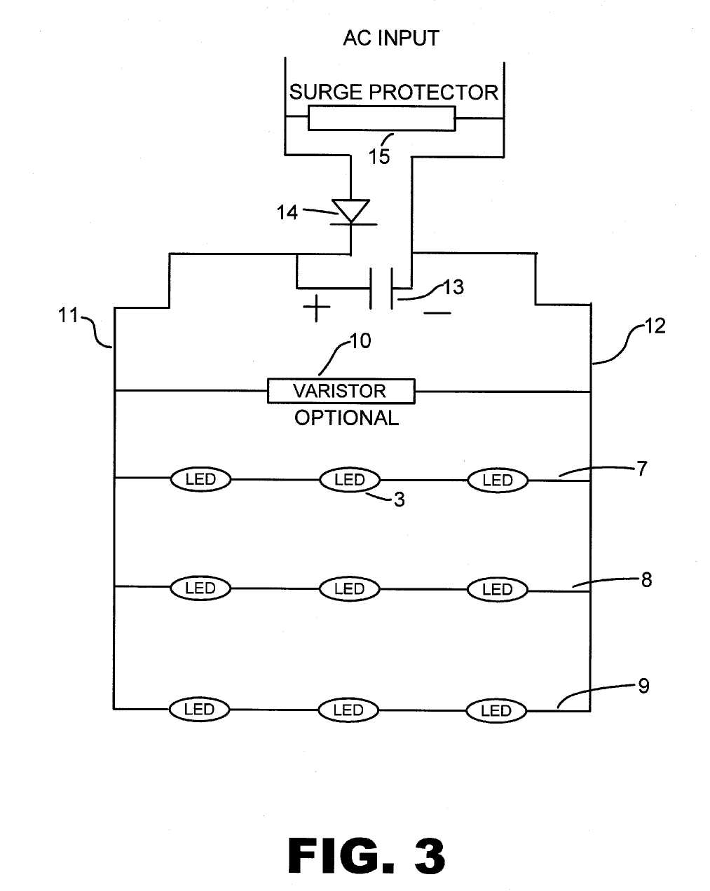

FIG. 3 shows a circuit that could possibly be used with an AC input. AC voltage is rectified using a diode 13 and a capacitor 14. A varistor 10 in the DC side of the circuit is still shown; however, this is optional for additional protection. An AC surge protector 15 is shown across the AC input. AC surge protectors are known in the art and may contain varistors and other devices. If the projector power supply supplies an AC surge, an AC surge protector (not shown) can be used across the AC input line. Most projectors, whether DC or AC supply around 10 to 40 volts. While FIG. 3 shows a half-wave rectifier, a full-wave or bridge rectifier could also be used. A transformer could also be inserted before the rectifier if the AC voltage needed to be changed before rectification as is known in the art.

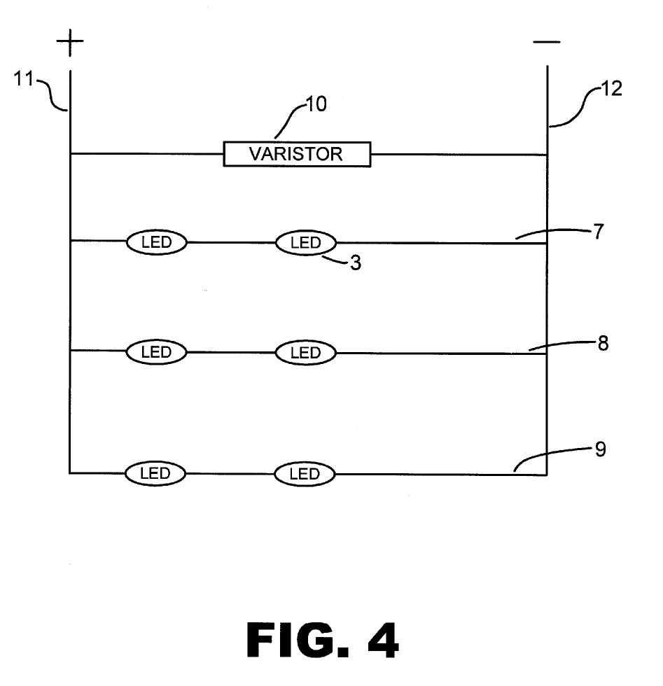

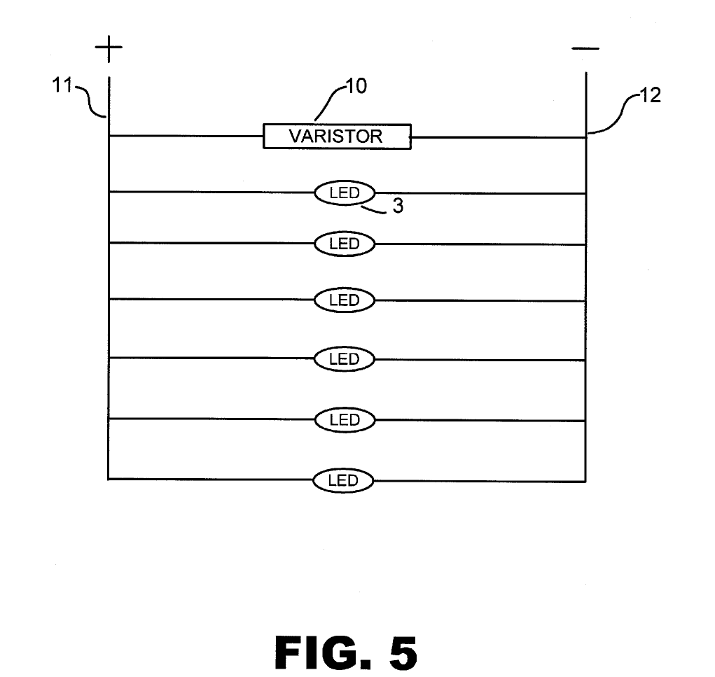

FIG. 4 shows a DC configuration with three parallel groups of two series LEDs each. FIG. 5 shows six LEDs connected in parallel.

As previously stated, the present invention is not limited to any particular type or color temperature LED, nor is it limited to any particular series/parallel arrangement of the LEDs. Any LEDs that can supply enough light output can be used in any series/parallel arrangement.

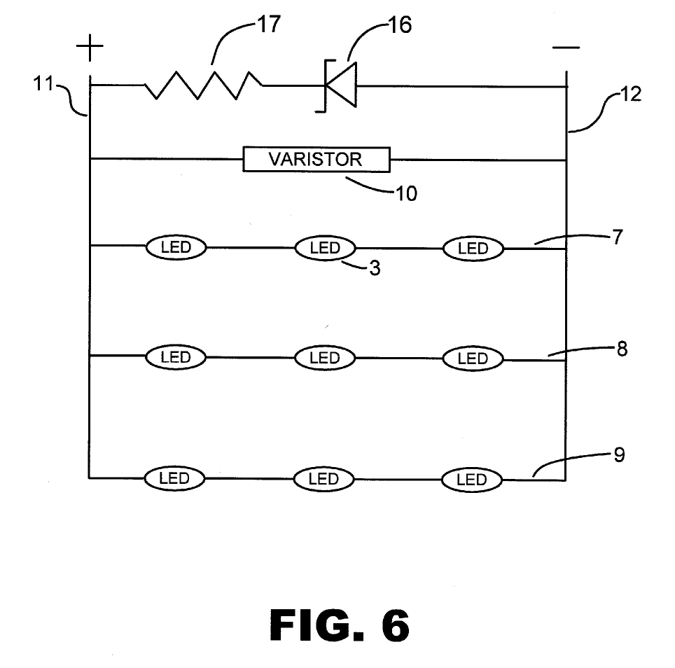

FIG. 6 shows an arrangement similar to that of FIG. 2 with a high wattage zener diode safety device 16 electrically coupled across the DC input 11, 12. This zener 16 can be reversed biased, in cutoff to protect against too large a DC voltage; however, lamp power supplies generally tend to raise their voltage outputs until they sense a correct current range. The zener can be chosen to enter into partial conduction to provide the correct current range. An optional resistor 17 can be placed in series with the zener 16 to limit current if it conducts; however, this may not be necessary. A possible zener that could be used is a 1N3309B which is an approximately 10 volt, 50 watt zener. Numerous other zener diodes can be used with different lamp power supplies depending on voltage and current outputs and sensing from these supplies.

Several descriptions and illustrations have been presented to aid in understanding the features of the present invention. One skilled in the art will realize that numerous changes and variations are possible without departing from the spirit of the invention. Each of these changes and variations is within the scope of the present invention.

I claim:

1. A replacement module for an arc lamp projector bulb assembly comprising:
a plurality of LEDs wired in an array on a heat sink, said array having a positive electrical terminal and a negative electrical terminal;
a collimator mounted in front of said LEDs;
a surge connector electrically connected across said positive electrical terminal and said negative electrical terminal;
wherein, said replacement module fits a projector bulb module form factor.

2. The replacement module of claim 1 further comprising a reflector mounted behind said series/parallel array.

3. The replacement module of claim 1 wherein said surge connector is a varistor.

4. The replacement module of claim 1 further comprising an AC power supply converting AC to DC to drive said LEDs.

5. The replacement module of claim 4 further comprising a half-wave rectifier.

6. The replacement module of claim 1 wherein said heat sink is cooled by a projector fan.

7. The replacement module of claim 1 wherein said array contains either 6 LEDs connected in parallel or 3 sets connected in parallel of 2 LEDs each.

8. The replacement module of claim 1 wherein said array contains a plurality of groups with 2 or 3 LEDs connected in series, said groups connected in parallel.

9. The replacement module of claim 1 further comprising a zener diode electrically coupled between said positive and negative electric terminals.

10. A replacement module for an arc lamp projector bulb from a light projector assembly comprising:
a plurality of LEDs wired in an array on a heat sink, said array having a positive electrical terminal and a negative electrical terminal, said array containing either 6 LEDs connected in parallel or 3 groups with 2 LEDs per group connected in series, said groups connected in parallel;
a collimator mounted in front of said LEDs;
a surge connector electrically connected across said positive electrical terminal and said negative electrical terminal;
wherein, said replacement module fits a projector bulb module form factor and said heat sink is cooled by a fan in said light projector.

11. The replacement module of claim 10 wherein said surge protector is a varistor.

12. The replacement module of claim 10 further comprising an AC power supply converting AC to DC to drive said LEDs

13. A method of providing a replacement light source for a projector lamp using an LED array device with a form factor matching that of said projector lamp, said LED array device containing a plurality of LEDs connected in series, parallel or series/parallel with a DC voltage input comprising:
providing a plurality of series connected, parallel connected or series/parallel connected LEDs mounted on a heat sink, wherein said heat sink can be cooled by a projector fan;
providing a collimator mounted in front of said plurality of LEDs;
connecting a surge protector across said DC voltage input;

14. The method of claim 13 further comprising providing an AC to DC conversion circuit before said DC voltage input.

15. The method of claim 14 wherein a reflector is mounted behind said plurality of LEDs.

16. The method of claim 13 further comprising connecting a zener diode across said DC voltage input.
